(19) United States
(12) Patent Application Publication
(10) Pub. No.: US 2003/0056145 A1
(43) Pub. Date: Mar. 20, 2003

(54) Device for ensuring specifically optimized error handling in complex systems

(75) Inventor: Rainer Kuth, Herzogenaurach (DE)

Correspondence Address: YOUNG & THOMPSON, 745 SOUTH 23RD STREET 2ND FLOOR, ARLINGTON, VA, 22202

(73) Assignee: SIEMENS Aktiengesellschaft

(21) Appl. No.: 09/954,165

(22) Filed: Sep. 18, 2001

(30) Foreign Application Priority Data
Sep. 18, 2001 (DE) 100 46 096.8

(51) Int. Cl. H04L 1/22

(52) U.S. Cl. 714/21

(57) ABSTRACT

A device for ensuring specifically optimized error handling in complex systems, in particular in computer-supported medical diagnostic systems, characterized by a system-end storage and evaluation device (local error handler) having an error evaluation program which handles and stores local error messages and application programs according to specific rules, for automatically determining of when it is necessary to make contact with the server of a maintenance center, an update of the error software being carried out in the local error handler, when necessary, after a message has been checked.

The invention relates to a device for ensuring specifically optimized error handling in complex systems, in particular in computer-supported medical diagnostic systems.

Operators of complex computer-supported systems generally need specialist support by their system partner, for example a manufacturer or a maintenance center. This applies to a particular degree to computer-supported medical diagnostic systems such as MR equipment where there is a large number of parameters which determine the quantity and quality of the output. Because of the high degree of complexity, even of the routine work, and the fact that the users of these highly complex technical systems are of course generally medical practitioners or medical personnel, there is a need for targeted support and consultancy services provided by experts which the system operator can of course usually not make available from his own resources.

With such complex systems, it has previously been the practice to continuously carry out systematic training of the operating personnel, and there are also frequent visits to local sites by experts. When problems occur, the customers also demand support services by these experts and they are then made available to the customers by telephone or in situ after a respective time delay. Apart from the fact that the optimum support is frequently not made available quickly enough, for the service providers there is the problem of correctly estimating the requirements or the demands of a plurality of customers and prioritizing them in an optimum way.

U.S. Pat. No. 5,394,543 A has already described a device for ensuring specifically optimized error handling with a system-end storage and evaluation device in order to handle error messages and application problems according to predetermined rules and if appropriate make contact with the server of a maintenance center. The latter can, inter alia, then also detect certain error structures which result from the acknowledgement of a large number of local error handlers. However, the local error handler, and in particular its expert system and its evaluation devices, remain unchanged in such a context.

Correspondingly, the same also applies to a medical diagnostic system such as is known from DE 199 16 055 A1. The error listings of individual blocks are compared with archive error listings in order to find resulting solution proposals to the problems which have occurred. The handling of the errors in the local collection point is however not changed in this method.

This finally applies also to an error handling device such as is described in the publication “Research Disclosure”, June 1999, page 815, 42261 “Vehicle Diagnostics Performed via the Internet”. In this application, the error data collected in a local PC of a vehicle and evaluated according to predefined rules is, if appropriate, passed on to a diagnostic computer of the vehicle dealer or manufacturer. The internal operational sequence of the error handling in the local system remains unaffected.

The invention is therefore based on the object of providing a device for ensuring a specifically optimized error handling system in complex diagnostic systems, in particular in computer-supported medical diagnostic systems, which can to a very great extent independently detect and assess errors and in this way can establish a better request dialog with the service provider.

In order to achieve this object, such a device is characterized according to the invention by a system-end storage and evaluation device (local error handler) having an error evaluation program which handles and stores local error messages and application problems according to specific rules, for automatically determining of when it is necessary to make contact with the server of a maintenance center, an update of the error software being carried out in the local error handler, when necessary, after a message has been checked.

The local error handler, which can be connected to the central server via the Internet or modem switched circuit interrogates, for example automatically at predefinable time intervals, the error protocols in the system for new messages and evaluates these new messages both individually and in terms of their time sequence and frequency.

Of particular importance here is the updating of the error software in the local error handler by the central server in accordance with newer knowledge and error causes acquired as a result of the monitoring of a multiplicity of such systems. This ensures that specific errors which have proven particularly fatal can lead to specific actions and such errors which are instead harmless can also be appropriately categorized.

It lies within the scope of the invention here that the local error messages also comprise automatic checks of quality and quantity of the system output, for example the signal-to-noise ratio, the measuring times, the number of repeated measurements or the dead times when patients are changed.

In refinement of the invention, in the central server of the maintenance center or of the manufacturer there is an error assessment device which is connected to a QS system manager which, when necessary, automatically brings about maintenance work on the system. In this way, necessary repairs can be initiated much more quickly and in a way which is better adapted to the individual case because a serious error which occurs in the system, or even its cause, can be quickly and reliably detected with a high degree of certainty by means of the automatic error assessment from a series of the local messages, which have already been described above, for example the signal-to-noise ratio which is not very revealing to the operator and also cannot be detected, and as a result a total system failure which may possibly occur if such maintenance work is delayed, can be avoided by initiating maintenance works.

Further advantages, features and details of the invention emerge from the following description of an exemplary embodiment and by reference to the drawing, in which:

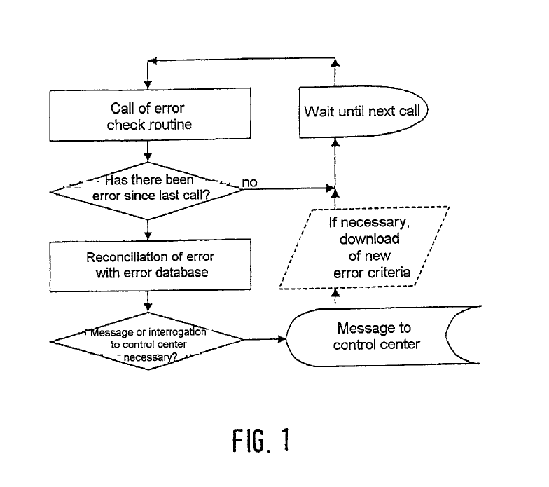

FIG. 1 shows a flowchart of the error checking and reporting in a local error handler, and

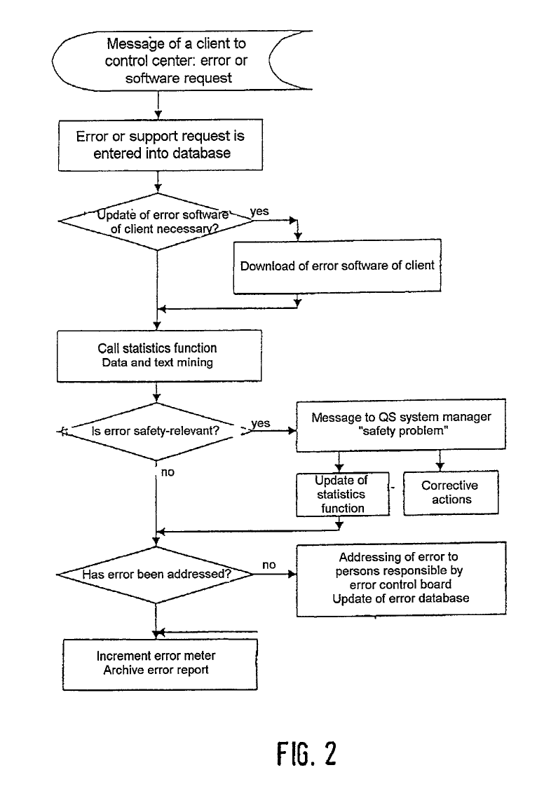

FIG. 2 shows a flowchart explaining the application support in the maintenance center.

The error handling with the schematic sequence according to FIG. 1 is a continuously active process. It polls all the relevant error loggers, i.e. error protocols in the system, for new messages at regular time intervals, for example once per minute. In addition, the error handler senses activities on the system which lie outside the normal use, for example a measurement is carried out twice, an operator reports a problem via a screen dialog, in which direct interrogations can be made by the error handler to the operator, for example “image quality ok?”, “measuring time ok?”, “signal-to-noise ratio?” etc. The error handler identifies new messages as errors by reference to the local error databases. In the error database which can be renewed by the central server of the service provider (see also FIG. 2 in this respect), messages are also characterized in terms of whether a message or interrogation to the control center is necessary. If such a message is necessary, this is transmitted to the central server of the service provider, which can be carried out, for example, via the Internet or a modem switched circuit (for example X400).

FIG. 2 illustrates schematically by way of a flowchart how the central server of a service provider processes incoming messages of a local error handler.

All the messages are transmitted directly into a database after receipt. The server checks immediately whether it is necessary to update the error software in the error database of the client sending the message, and, if appropriate, transmits an update. The server then tests, by means of a reconciliation with the database, whether the error is a safety-related error. If that is the case, he informs the relevant locations. The database is updated in parallel. It is then checked whether the error was already known and addressed to a processor. If this is not the case, the error is transmitted to the respective party which addresses the error and the database is updated again.

The process ends with the archiving of the error, in which case an optional acknowledgement to the customer is also possible.

1. A device for ensuring specifically optimized error handling in complex systems, in particular in computer-supported medical diagnostic systems, characterized by a system-end storage and evaluation device (local error handler) having an error evaluation program which handles and stores local error messages and application problems according to specific rules, for automatically determining of when it is necessary to make contact with the server of a maintenance center, an update of the error software being carried out in the local error handler, when necessary, after a message has been checked.

2. The device as claimed in claim 1, characterized in that the local error handler is connected to the central server via the Internet or via a modem switched circuit.

3. The device as claimed in claim 1 or 2, characterized in that the local error handler automatically interrogates the error protocols in the system for new messages at predefinable time intervals and evaluates said new messages both individually and in terms of their time sequence and frequency.

4. The device as claimed in one of claims 1 to 3, characterized in that the local error messages also comprise automatic checks of quality and quantity of the output system, for example the signal-to-noise ratio, the measuring times, the number of repeated measurements or the dead times when patients are changed.

5. The device as claimed in one of claims 1 to 4, characterized in that the central server has an error assessment device which is connected to a QS system manager which, if necessary, automatically brings about maintenance work on the system.
